(19) United States
(12) Patent Application Publication
(10) Pub. No.: US 2024/0253257 A1
(43) Pub. Date: Aug. 1, 2024

(54) ADJUSTMENT DEVICE FOR A HAIR-CUTTING APPLIANCE

(71) Applicant: WAHL GMBH, St. Georgen (DE)

(72) Inventors: Gerd EMMINGER, Niedereschach (DE); Tobas HAUSER, Königsfeld (DE); Stephan HETZINGER, Schorndorf (DE); Philipp RUFFING, Hockenheim (DE); Armin STIEGELE, Fellbach (DE)

(73) Assignee: WAHL GMBH, St. Georgen (DE)

(21) Appl. No.: 18/283,924

(22) PCT Filed: Mar. 18, 2022
(86) PCT No.: PCT/EP2022/057243

§ 371 Date: Apr. 12, 2024

(30) Foreign Application Priority Data
Mar. 24, 2021 (EP) 21164733.4

(51) Int. Cl. B26B 19/20; B26B 19/04; B26B 19/42

(52) U.S. Cl. CPC B26B 19/20; B26B 19/04; B26B 19/42

(57) ABSTRACT

Adjustment device (10) for a hair cutting device (20), the hair cutting device (20) having a device housing (22) and a cutting set (24) connected to the device housing (22), the cutting set (24) of a shear blade (26), which contains shear blade tips (30), and a shaving comb (28) connected therewith, which contains comb tips (32), wherein the shaving comb (28) is connected to the shear blade (26) and thus also releasably connectable to the hair cutting device (20). The adjustment device (10) is dimensioned in such a way that it can receive and hold the shaving comb (28) so that after loosening the connecting elements (62), the shaving comb (28) together with the adjustment device (10) is movable relative to the device housing (22) so that a distance between the shear blade tips (30) and the comb tips (32) can be set.

The present invention relates to an adjustment device for a hair cutting appliance according to the preamble of claim 1.

Hair cutting devices, in which the cutting action is achieved by moving blades back and forth, have long been known. In such hair cutting devices, the distance in a blade set, i.e. the distance between a movable cutting part (blade) and a stationary cutting part (comb) can be individually adjusted by the end user in order to be able to achieve the desired result.

In a hair cutting device with a movable blade and a stationary blade, i.e. a blade that is firmly connected to the hair cutting device and is not movable in the horizontal and/or vertical direction, when the hair cutting device is operated, the movable blade moves laterally relative to the stationary blade back and forth. The movable and stationary blades are adjustable relative to one another in a direction perpendicular to a reciprocating movement direction. Even with a hair cutting device having two movable blades, these blades reciprocate relative to each other and can be adjusted in a direction perpendicular to a reciprocating movement direction.

The distance between the two hair cutting parts is adjusted by loosening fasteners by hand using a tool and before using the hair cutting device. The fastening elements are usually screws which are located on a lower part of the hair cutting device and which connect the movable blade to a guide which is held by the stationary blade. Completely loosening or loosening the screws will set the blades to the desired spacing. The screws must be tightened enough after setting the distance so that they cannot loosen when the hair cutting device is then used.

The “barber trend” that has emerged in recent years continues and is increasingly influencing the classic hairdressing trade. For certain types of precise hair cutting and trimming operations, such as outlining details or cutting lines or patterns in a person's hair or the edge of a person's hairline, whether facial, scalp or body hair, it is desirable that the distance between the so-called stationary hair blade and the shear blade lying on it is set as small as possible.

For certain applications of the hair cutting devices, such as outlining details or cutting lines or patterns in a person's hair, and cutting the edge of a person's hairline, there is an increased demand for extremely short cut lengths.

The teeth of the moving blade are typically offset from the teeth of the stationary blade to avoid cutting the skin of an animal or person whose hair or beard is being cut. In order to avoid undesirable skin damage, the movable blade should be adjusted before the cutting process in such a way that it is offset by a very small distance from the stationary blade.

It is thus desirable to adjust the hair cutting device prior to use in such a way that the distance between the stationary hair blade and the shear blade is set and kept as small as possible in order to achieve extremely short cutting lengths with a conventional hair cutting device.

Heretofore, such adjustments of the distance between the movable and the stationary hair blade, which are known in the art as zero overlap adjustment, have been made by a user who uses hair cutting devices professionally with the naked eye or with the aid of adjusting devices. In the past, the cutting set had to be completely removed or dismantled for adjustment and then reinstalled in the hair cutting device after the adjustment was carried out by eye.

Such adjustments of the distance between the movable and the stationary hair blade should, however, be made very precisely and require a certain technical know-how that not every user of hair cutting devices and in particular professional hair cutting devices such as a hairdresser can bring with them. However, an incorrect setting of the two cutting parts can lead to damage to the skin of the person or animal to be treated.

Thus, there is a need for an adjusting device which enables the end user to consistently adjust the cutting sets to, among other things, extremely small spacing between the shear blades for precise hair cutting operations.

An object of the present invention is therefore to provide an adjusting device for a hair cutting device which enables a user to adjust the cutting sets in a simple manner and reproducibly to a maximum short distance from one another, so that a maximum short cutting length can be achieved safely and with the least amount of work minimizing the risk of skin injuries.

This object is achieved according to the invention by an adjusting device for a hair cutting device with the features of claim 1.

Preferred embodiments of the present invention emerge from the dependent claims.

In order to enable a better understanding of the adjusting device according to the invention for a hair cutting device, the terms and definitions used here are explained in more detail below.

The upper, movable part of the cutting set is referred to as the “shear blade” and the lower, larger cutting set part is referred to below as the “shaving comb” or simply “comb”. The combination of a shear blade and shaving comb with any add-on parts is referred to as a “cutting set”. The device without the cutting set is referred to below as the “hair cutting device”.

Furthermore, the “shear blade to comb distance” to be set with the adjusting device according to the invention is referred to as the distance from the sheaving comb tooth tip to the shear blade tooth tip. The “cutting length” denotes the shortest distance from the tip of the shear blade to the comb edge.

The blade is geometrically positively guided by a so-called “linear guide” between the shear blade and the guide piece. Thus, the shear blade to comb distance and the parallelism in the on and off state are unchanged.

With a radial blade movement, however, the shear blade moves in a circular arc. The shear blade to comb distance and the parallelism in the ON and OFF state change continuously. In the OFF state, the shear blade is always on the right or left side due to the force applied inside the housing of the hair cutting device.

A hair cutting device has a device housing and a cutting set firmly connected to the device housing. The cutting set consists of a shear blade, which comprises shear blade tips, and a shaving comb connected to it, which comprises comb tips. The shaving comb is detachably connected to the shear blade and thus also to the hair cutting device by means of connecting elements such as screws.

The adjusting device according to the invention for such a hair cutting device is characterized in that it is dimensioned in such a way that it can receive and hold the shaving comb, so that the shaving comb can be moved together with the adjusting device relative to the device housing after loosening or partially loosening the connecting elements, so that a distance between the shear blade tips and the comb tips can be set.

Thus, with the device according to the invention, it is possible to set the shear blade tips and the comb tips to a maximally short distance from one another without having to dismantle and remove the entire cutting set from the device housing for the setting.

In this way, on the one hand, the risk of injuries that the operator can inflict when removing the shear blade is substantially minimized.

On the other hand, the distance is set in a simple but nevertheless precise manner, so that a maximally short cutting length can be achieved with the least possible amount of work. A so-called zero-overlap setting can thus be carried out very precisely with the adjusting device according to the invention, without this setting being dependent on the skill and experience of the user.

In addition, with the adjusting device according to the invention, a very fast and therefore time-saving setting of the shear blade tips and the comb tips of the cutting set can be carried out, which is particularly important when the hair cutting devices are used professionally.

Preferably, the shaving comb lies in a defined manner with the comb tips on the adjusting device, which is dimensioned accordingly to securely receive and hold the shaving comb so that the setting can be carried out.

The adjusting device according to the invention is preferably positioned together with the shaving comb in such a way in relation to the shear blade that the adjusting device rests in a defined manner on the shear blade tips of the shear blade. Thus, a defined, minimally possible distance between the shear blade tips and the comb tips is achieved, preferably by displacing the loosened parts of the cutting set to one another, without having to detach them from one another and insert them individually in the adjusting device.

It is considered to be particularly preferred if the adjusting device is essentially box-shaped and comprises a bottom, a front wall extending perpendicular to the bottom and at least one side wall extending perpendicular to the bottom for the defined receiving and holding of the shaving comb and the associated shear blade. The bottom is dimensioned in such a way that its dimensions correspond to the external dimensions of the cutting set and in particular of the shaving comb. Thus, the cutting set can be securely received and retained in the substantially box-shaped device.

The bottom of the adjusting device according to the invention preferably has at least one recess which corresponds to the connecting elements of the shaving comb in order to loosen or resolve the connecting elements of the shaving comb when the shaving comb and the shear blade are completely accommodated in the adjusting device.

The front wall of the adjusting device has an inwardly protruding projection at a front end remote from the hair cutting device, for setting a specific offset distance between an edge of the shaving comb and an edge of the shear blade, the projection serving as an abutment for the edge of the shear blade. The edge of the shaving comb lies under the abutment when it is inserted. In this way, the distance between the cutting edge and the shaving comb edge is precisely set.

A preferred embodiment of the present invention provides that the projection is formed protruding on an upper edge of the front wall so that it forms abutment for the shear blade, the shaving comb lying under the shear blade being arranged under the abutment in the assembled state of the cutting set.

According to a preferred embodiment, the abutment can taper downwards in the direction of the bottom of the adjusting device, forming a slope.

The projection can, however, also have a rounding or be configured as a web. It is important that the projection or the abutment extends along an inner side of the front wall so that it corresponds to the edge of the shear blade. The projection can be formed continuously along the front wall or it can also have interruptions in its direction of extension, so that the shear blade can also lie on partial sections.

In order to securely lock the shaving comb and the shear blade with the adjusting device, one or more rear snap hooks, which is/are arranged opposite to the front wall, are preferably provided. Thus, the cutting set cannot be unintentionally released from the adjusting device, so that the setting can be carried out safely and conveniently for the user and the risk of injuries is substantially minimized.

A rear snap hook is preferably provided opposite to the front wall of the adjusting device for locking the shaving comb and shear blade when they are inserted into the adjusting device as a unit. This ensures that the cutting set is held securely in the adjusting device. The snap hook can also be provided, for example, on one or both side walls.

The adjusting device according to the invention preferably has two side walls extending parallel to one another, which are connected to the front wall and have lateral guides on the inside for the parallel alignment of the shaving comb and the shear blade to one another, with gripping areas being provided on the outside of the side walls in order to only secure the device with to be able to hold with one hand.

Another preferred embodiment provides that the above-mentioned lateral guides provided on the inside are configured as spring tongues so that they can easily align the shaving comb and the shear blade parallel to one another when they are pushed into the adjusting device.

A further preferred embodiment of the present invention provides that the adjusting device comprises a bottom, a front wall extending perpendicular to the bottom and a rear wall extending perpendicular to the bottom for receiving and holding the shaving comb and the shear blade attached thereto, with lateral limits for correct positioning of the shaving comb and the associated shear blade and for holding the adjusting device are provided, and wherein the bottom is placed approximately centrally between the front wall and the rear wall. The front wall and the rear wall extend upwards and downwards over the bottom, so that the adjusting device can be used on both sides for two different cutting sets or different hair cutting devices.

The adjusting device preferably has a first bottom and a second bottom which extend parallel to one another and are laterally connected to one another by side walls which are arranged parallel to one another, the adjusting device having a front wall which is connected to the side walls and is arranged substantially perpendicular to the side walls, the first and the second bottom extending from the front wall at an angle of approximately 50° upwards in the direction of a hair cutting device to be inserted. In this case, the front wall preferably has a projection on each of its surfaces corresponding to the two bottoms for adjusting the shear blade with respect to the shaving comb.

Preferably, the front wall according to the above embodiment has projections at an upper end and at a lower end for adjusting the shaving comb and the shear blade to each other, wherein the projections extend elongated, and wherein the rear wall at an upper end and a lower end inwardly is formed bent in order to hold the shaving comb and the shear blade in the position set relative to one another. The projections on the rear wall are configured to accommodate and hold two different sets of blades.

It can also be provided that the bottom wall is configured in two parts, the two parts running parallel to one another in the longitudinal direction of the adjusting device and being firmly connected to one another and extending upwards and downwards at their two opposite ends, so that they form a box.

According to a further embodiment of the present invention, the adjusting device has a bottom, a side wall, a front wall and a rear wall, so that these form a laterally open box into which the hair cutting device with the built-in cutting set can be inserted laterally, the front wall having a lateral projection which comprises an abutment for adjusting the shear blade with respect to the shaving comb.

Another preferred embodiment provides that the bottom is web-like and dimensioned in such a way that it can be inserted into a slot provided between the shaving comb and the shear blade in the installed state, the positioning of the shear blade relative to the shaving comb via the slot.

Preferably, the adjusting device has a side wall which is firmly connected to the web-like bottom and extends from this perpendicularly in the longitudinal direction of the shaving comb, the adjusting device having a rear wall which is connected to the side wall essentially at right angles, so that the adjusting device laterally includes the cutting set and is suitable for setting the shear blade and the shaving comb. It is considered particularly preferred if the rear wall does not enclose the entire rear of the set of shears, so that free access to the connecting elements of the set of shears is guaranteed.

The adjusting device according to the invention can be configured in one piece or else in two or more parts.

Preferably, a two-part adjusting device has a first, inner part, which forms a receptacle for the cutting set and holds it pretensioned, and a second, outer part, which holds the pretension, the first part and the second part being displaceable relative to one another, to press the cutter in a central position.

In the case of a two-part adjusting device, the two parts can be made as separate parts and connected to one another before the adjusting device is used, or they can also be produced as separate parts that are configured as a unit, the two parts being displaceable into one another.

The first part of the two-part adjusting device preferably has a bottom, a front wall and two side walls which are connected to the bottom and which each comprise a spring tongue on their parts adjoining the front wall for fixing the shear blade in a central position.

Preferably, the first part and the second part of the respective front wall each comprise corresponding recesses opposite each other, which are connected to the connecting elements of the shaving comb.

A particularly preferred embodiment of the two-part adjusting device provides that the side walls of the first part each have a longitudinally extending web for the axial guidance of the second part on their outer sides adjoining the second part, the second part being configured in such a way that it has corresponding side walls, each having an elongated recess or a groove for receiving the respective adjacent web.

The second part of the two-part adjusting device preferably has a bottom, on the inner surface of which, opposite the shaving comb, a projection is provided for engaging the shaving comb. Particularly preferably, in the first and/or in the second part of the adjusting device, a recess formed in the respective bottom is provided for receiving a tool, the tool being graspable and removable in a completely closed or in an open position of the adjusting device in order to at least partially release the connecting elements of the shaving comb.

The recess for the tool provided in the first and/or second part is preferably configured as a continuous opening which is circular, cross-shaped and polygonal in shape and is suitable for securely receiving differently shaped tools.

It is considered to be particularly advantageous that the adjusting device according to the invention for a hair cutting device not only for cutting sets in which the shear blade and the comb are positioned relative to one another by means of connecting elements and can be removed from the hair cutting device, but also for cutting sets in which the shear blade and comb can only be positioned with respect to one another via the hand-held device. The cutting set does not have to be dismantled for the adjustment of the hair cutting device.

The adjusting device according to the invention for a hair cutting device can, however, also be used to dismantle the shaving comb for cleaning the hair cutting device and to reassemble it properly on the hair cutting device.

Advantageous further developments emerge in the following from the dependent claims and from the following exemplary embodiments, as shown in more detail in the drawings.

### BRIEF DESCRIPTION OF THE DRAWINGS

FIG. 1a shows a hair cutting device with a cutting set with a radial blade movement in plan view;

FIG. 1b shows an enlarged illustration of the cutting set of the hair cutting device according to FIG. 1a;

FIG. 2a shows a hair cutting device with a cutting set with a linear shear blade movement in plan view;

FIG. 2b shows an enlarged view of the cutting set of the hair cutting device according to FIG. 1a;

FIG. 3 shows a perspective view of an inventive adjusting device in accordance with a first exemplary embodiment of the present invention;

FIG. 4 shows a perspective view of an inventive adjusting device in accordance with a second exemplary embodiment of the present invention;

FIG. 5a shows a perspective view of an adjusting device according to the invention in accordance with a third exemplary embodiment of the present invention;

FIG. 5b shows a front view of the adjusting device according to FIG. 5a;

FIG. 5c is a sectional view taken along the line D-D in FIG. 5b;

FIG. 6 shows a perspective view of a hair cutting device and the adjusting device shown in FIG. 5a in the inserted and assembled state;

FIG. 7a shows a perspective view of an inventive adjusting device according to a fourth embodiment of the present invention;

FIG. 7b shows a side view of the adjusting device according to the invention according to FIG. 7a with the cutting set inserted;

FIG. 7c shows a perspective view of a hair cutting device and the adjusting device shown in FIG. 7a in the inserted and assembled state;

FIG. 8a shows a perspective view of an adjusting device according to the invention according to a fifth embodiment of the present invention;

FIG. 8b shows a front view of the adjusting device according to FIG. 8a;

FIG. 8c is a sectional view along the line E-E in FIG. 8b;

FIG. 8d shows a top view of the adjusting device according to FIG. 8a with the cutting set inserted;

FIG. 8e shows a perspective view of a hair cutting device and the adjusting device shown in FIG. 8a in the inserted and assembled state;

FIG. 9a shows a perspective view of an adjusting device according to the invention in accordance with a sixth embodiment of the present invention;

FIG. 9b shows a front view of a cutting set of a hair cutting device and the adjusting device according to FIG. 9a;

FIG. 9c is a partial sectional view of the cutting position and the adjusting device along the line C-C in FIG. 9b;

FIGS. 9d, 9e perspective representations of a hair cutting device and the adjusting device shown in FIG. 9a;

FIG. 10a shows a perspective view of an inventive adjusting device according to a seventh embodiment of the present invention;

FIG. 10b shows a plan view of the adjusting device according to FIG. 10a with a cutting set inserted therein;

FIG. 10c is a sectional view taken along line A-A in FIG. 10b;

FIG. 10d shows perspective representations of a hair cutting device and the adjusting device shown in FIG. 10a;

FIG. 10e shows a plan view of the adjusting device according to FIG. 10a with a cutting set inserted therein;

FIG. 10f is a sectional view taken along line B-B in FIG. 10e;

FIG. 10g shows perspective representations of a hair cutting device and the adjusting device shown in FIG. 10a;

FIGS. 11a-11f show an adjusting device according to an eighth embodiment of the present invention;

FIG. 11g shows the adjusting device according to the eighth embodiment with the hair-cutting device inserted;

FIGS. 12a-12h show an adjusting device according to a ninth embodiment of the present invention;

FIGS. 13a-13c show the adjusting device according to FIGS. 12a-12h with a hair-cutting device inserted therein; and

FIGS. 13d, 13e the adjusting device according to FIGS. 12a-12h with a tool.

In the following, preferred embodiments of the present invention are explained in more detail with reference to the drawings. Identical and equivalent technical features are provided with the same reference symbols in the figures.

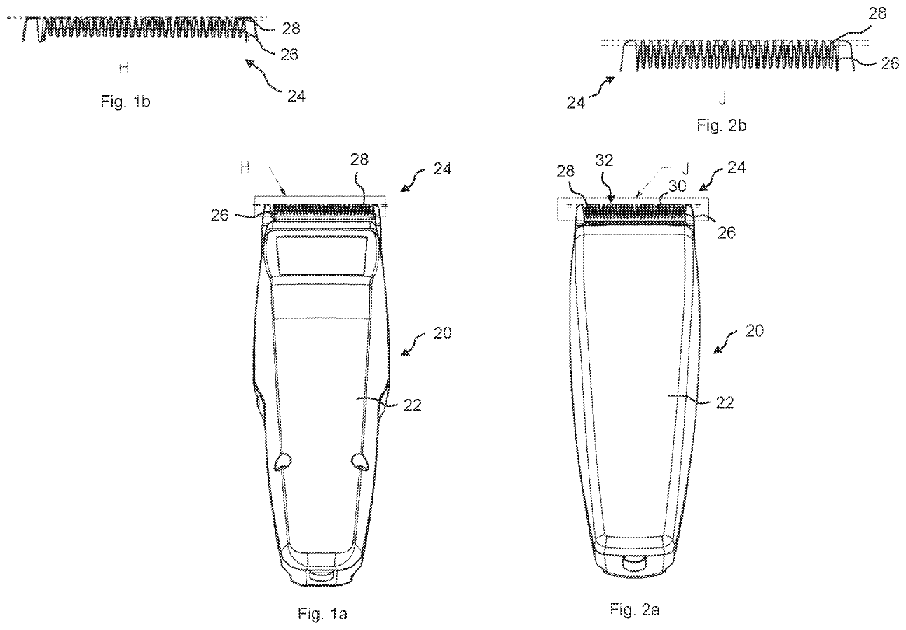

In order to explain the effect of the adjusting device according to the invention for a hair cutting device, reference is made to FIGS. 1a, 1b and 2a, 2b, which show two hair cutting devices 20 with the respective cutting sets 24.

In FIG. 1a, a hair cutting device 20 is shown in a plan view. The hair cutting device 20 has a device housing 22 and a removable cutting set 24. The cutting set 24 consists, in a manner known per se, of a shear blade 26 and a shaving comb 28 lying underneath, corresponding to and connected to the shear blade 26, wherein in this embodiment the cutting set 24 is a cutting set with a radial shear blade guide.

With a radial shear blade guide, the shear blade 26 moves in a circular arc. The shear blade to comb distance, which is shown in FIG. 1a, and the parallelism in the ON and OFF state change continuously in the radial shear blade guide. In the OFF state, the shear blade 26 is always on the right or left side due to a spring force acting on it.

The hair cutting device 20 shown in FIG. 2a differs from that shown in FIG. 1a by the linear shear blade guide. Due to the linear guide on the cutting set 24, the shear blade to comb distance and the parallelism in the ON and OFF state are always constant.

The shear blade to shaving comb distance of the respective cutting set 24 shown enlarged in FIG. 1b and in FIG. 2b is almost 0 mm. For some applications of a hair cutting device, it is important that there is practically no distance between the edges of the shear blade and the shaving comb, so that the cutting edges are essentially covered.

In the case of a linearly guided shear blade, as shown in FIG. 2a, it is assumed that the shear blade 26 and the shaving comb 28 are already parallel to one another.

In the case of a radially guided shear blade, as shown in FIG. 1a, there is an angular offset, depending on the position in which the shear blade comes to a standstill. Thus, in order to bring the shear blade 26 into a central position, the shear blade 26 and the shaving comb 28 must be positioned parallel to one another. The shear blade tips 30 and the comb tips 32 are thereby covered, as shown in FIG. 1a, it being possible to achieve a minimal distance between them.

It is therefore necessary that the adjusting devices are adapted and suitable for the respective configures of the cutting set of different hair cutting devices.

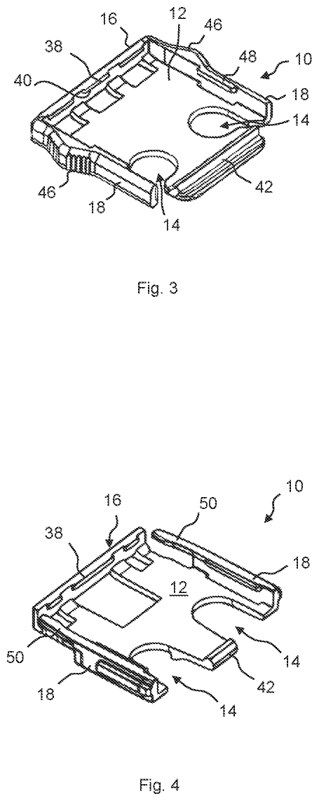

FIG. 3 shows a perspective illustration of an adjusting device 10 according to the invention in accordance with a first exemplary embodiment of the present invention. The adjusting device is essentially box-shaped and has a bottom 12, a front wall 16 extending perpendicular to the bottom 12, and two side walls 18 extending perpendicular to the bottom 12.

The adjusting device 10 configured in this way is dimensioned such that the dimensions of the bottom 12 and the walls extending upwardly perpendicular to the bottom 12 are suitable for receiving and holding a cutting set 24 of a hair cutting device 20, as shown in FIG. 1a. The shaving comb, not shown here, with the shear blade firmly connected to it, is inserted into the box-shaped adjusting device 10 and shifted forwards, in the direction of the front wall 16, until the tips of the comb lie against the front wall 16.

The two side walls 18 have elongated guides 48 on their upper edge, which provide a guide surface for inserting the cutting set of the hair cutting device. The elongated guides 48 are mirror-symmetrical so that the parallelism is ensured when the cutting set is inserted into the adjusting device 10 and it is thus ensured that the lower surface of the shaving comb 28 rests closely on the bottom 12 of the adjusting device 10.

In order to securely accommodate the shaving comb in the adjusting device 10, a snap hook 42 is provided, which in this embodiment extends parallel to the front wall 16 approximately in the center and is only connected in one piece to the bottom 12 of the adjusting device 10.

The bottom 12 of the adjusting device 10 has two recesses 14 which are dimensioned such that they are provided with connecting elements, usually screws, which are provided on the lower part of the cutting set for connection to the device housing of the hair cutting device.

The connecting elements can thus be easily detached or loosened without the entire cutting set having to be dismantled and separated from the device housing. Therefore, the distance between the shear blade tips and the comb tips can be adjusted quickly and reliably.

In order to precisely set the distance, the front wall 16 is dimensioned in the height direction in such a way that the comb tips extend as far as a lower edge of the projection 38. The shear blade tips, which lie directly on the comb tips, extend as far as the projection 38, so that the width of the projection 38 sets the distance between the shear blade tips and the comb tips.

Because the connecting elements are loosened in the adjusting device when the cutting set is inserted, a very precise setting of the two cutting elements with respect to one another can be achieved. After the setting process, the screws can then be pulled out again so that the cutting set can be removed from the box-shaped adjusting device 10 again together with the entire hair cutting device.

The adjusting device 10 shown in FIG. 3 has corrugated gripping areas 46, which are formed on the respective outer sides 56 of the side walls 18 in order to facilitate the insertion of the cutting set into the adjusting device 10 and removal from the adjusting device 10.

FIG. 4 shows a perspective illustration of an adjusting device 10 according to the invention in accordance with a second exemplary embodiment of the present invention. This embodiment differs from that shown in FIG. 3 in that the side walls 18 are not continuous and are not connected to the front wall 16. The side walls 18 extend perpendicularly in relation to the bottom 12 of the adjusting device 10 and each have a spring tongue 50 in the direction of the front wall 16, which are used to fix the shear blade in the central position.

In addition, in this embodiment the snap hook 42 is shorter than in the embodiment shown in FIG. 3, so that the recesses 14 are correspondingly larger, which increases the accessibility to the connecting elements of the cutting set and therefore facilitates the operability. By providing the spring tongues 50, which are used to fix the shear blade in the central position, this adjusting device 10 can also be suitable for hair cutting devices in which the shear blade movement is radial.

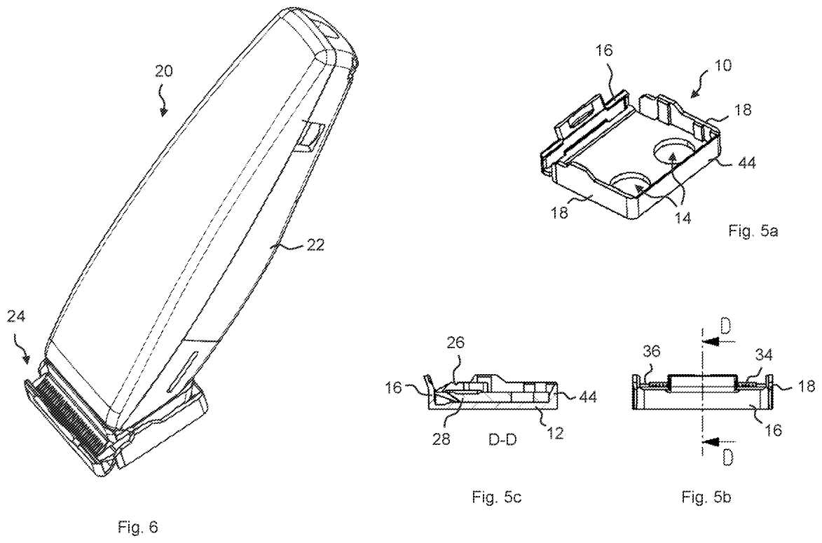

In FIG. 5a is shown a perspective view of an inventive adjusting device 10 according to a third embodiment of the present invention.

The adjusting device 10 according to the invention according to the third embodiment is characterized in that it is box-shaped and has a rear wall 44 which is connected to the side walls 18 and to the bottom 12. The front wall 16 is only connected to the bottom 12 and is configured to be elastic so that it acts as a kind of snap hook.

The front wall 16 is dimensioned in such a way that it corresponds to the cutting set and delimits it laterally, so that when the cutting set is inserted together with the device housing 22 into the adjusting device 10, the elastic front wall 16 serves as a snap hook and after loosening the connecting elements, not shown here, the shear blade 26 can be moved relative to the shaving comb 28. The edge 34 of the shear blade 26 and the edge 36 of the shaving comb 28 bear against the inner wall of the front wall 16, as shown in FIG. 5c, which is a sectional view along the line D-D of FIG. 5b. A zero-overlap setting can thus be easily implemented.

As shown in FIGS. 5a to 5c, the front wall 16 is formed in one piece, but it has a lower elongated section, which is connected to the bottom 12 and extends substantially at right angles upwards, and an upper section firmly connected to it, which is dimensioned shorter than the lower section and inclined outwards.

In order to insert the device housing 22 together with the cutting set 24 into the adjusting device 10 and to hold it securely until the setting is carried out, the cutting set 24 is inserted into the box-shaped adjusting device 10 from above and pressed down using a force until the edge 36 of the shaving comb 28 rests against the inner wall.

In FIG. 5a two recesses 14 are shown in the bottom 12 of the adjusting device 10, which are dimensioned such that they correspond to the connecting elements of the cutting set so that they can be easily loosened or released when the hair cutting device 20 is connected to the adjusting device 10.

As can be seen in the sectional view of FIG. 5c, in this embodiment the rear wall 44 is configured in such a way that a receptacle is provided for the rear part of the shaving comb 28, so that the rear wall 44 encompasses the shaving comb 28 and is thus connected without play.

A simple adjustment of the edge 34 of the shear blade 26 and the edge 36 of the shaving comb 28 can thus be carried out without having to separate them from one another. Thus, the hair cutting device 20 can be connected to the adjusting device 10 during the setting process, as shown in FIG. 6.

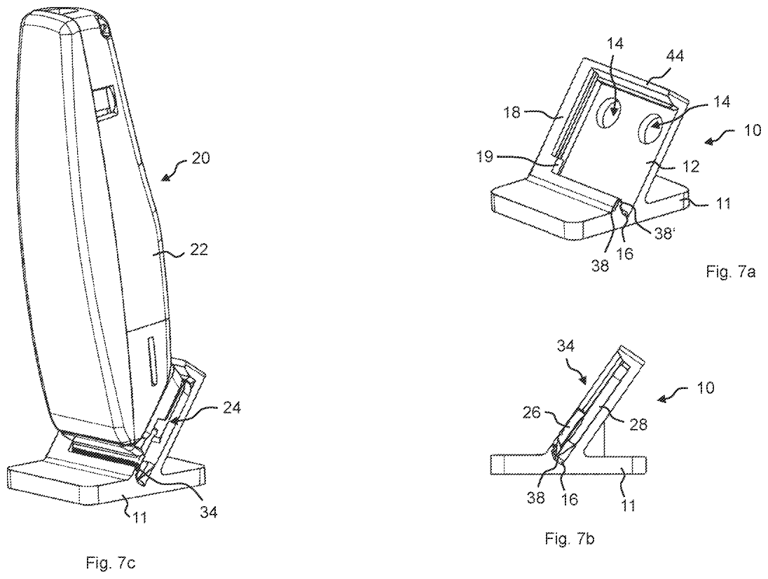

In FIG. 7a, a fourth embodiment of the adjusting device 10 according to the invention is shown in perspective. The adjusting device 10 is configured in such a way that it has a bottom 12, as in the other exemplary embodiments described above, a side wall 18 and a rear wall 44.

As shown in FIGS. 7a to 7c, a support surface 11 is provided so that the adjusting device 10 can be supported on a flat surface, with the bottom 12 and the one-piece side wall 18 and rear wall 44 connected to it at an angle of approximately 50° upwards from the flat support surface 11, so that when the hair cutting device 20 together with the cutting set 24 is laterally inserted into the adjusting device 10, the hair cutting device 20 extends substantially perpendicular to the support surface 11.

As shown in FIG. 7a, the bottom 12 has two recesses 14 which correspond to the connecting elements of the cutting set 24, so that the connecting elements can be loosened or released when the cutting set 24 is completely inserted into the adjusting device.

The front wall 16 is configured in such a way that it has a projection 38, as shown in FIGS. 7a and 7b. The comb tips extend as far as a lower edge of the projection, which corresponds to the bottom 12.

The shear blade tips of the shear blade 26, which lie directly on the comb tips of the shaving comb 28, extend up to the projection 38, so that the width of the projection 38 sets the distance between the shear blade tips and the comb tips, as shown in FIG. 7b.

As shown in FIG. 7a, the side wall 18 is configured in such a way that it has a projection 19 in the direction of the front wall 16. The projection 19 also extends in the direction of the open end of the adjusting device 10, via which the cutting set is guided into the adjusting device 10. Thus, the shaving comb 28 can be pushed completely into the adjusting device 10 up to the inner surface of the side wall 18.

The projection 19, which is formed on the upper part of the side wall 18, serves as a limitation for the shear blade 26 in the area of the shear blade tips, so that this embodiment is suitable for hair cutting devices with both a radial and a linear shear blade guide.

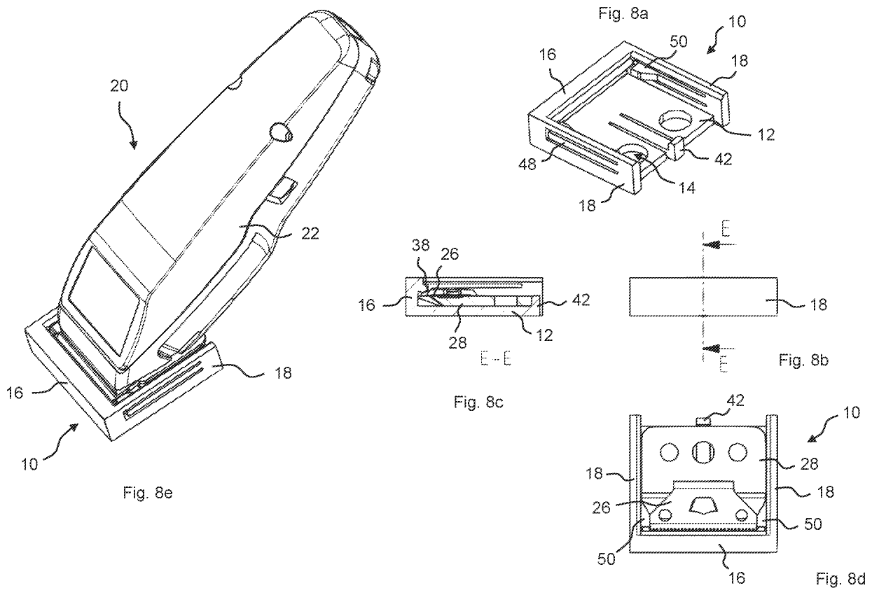

A fifth embodiment of the adjusting device 10 according to the invention is shown in FIGS. 8a to 8d. The adjusting device 10 has a bottom 12 in which two continuous recesses 14 are formed so that the connecting elements of the cutting set can be loosened or released through these recesses 14.

Furthermore, the adjusting device has two side walls 18 which extend parallel to one another and which are connected to the bottom 12′ and to a front wall 16. The side walls have lateral guides 48 on the inside for the parallel alignment of the shaving comb 28 and the shear blade 26, which are shown in FIGS. 8c and 8d. The lateral guides 48 are configured as spring tongues 50 so that they also serve as a holder for the shaving comb 28 and the shear blade 26.

The bottom 12 has, as shown in FIGS. 8a, 8c and 8d, at an end opposite the front wall 16 a snap hook 42 which, as shown in FIG. 8c, is configured to receive the shaving comb 28 and to hold it during the adjustment. The snap hook is formed centrally on the bottom 12′, between the two recesses 14.

As shown in FIGS. 8a, 8d, the lateral guides 48 are arranged in such a way that the spring tongues 50 only hold the shear blade, as can be seen from FIG. 8d, in the central position, so that an adjustment of the shear blade 26 relative to the shaving comb 28 is made laterally. This embodiment is therefore suitable for a hair cutting device 20 with a radial or linear shear blade guide.

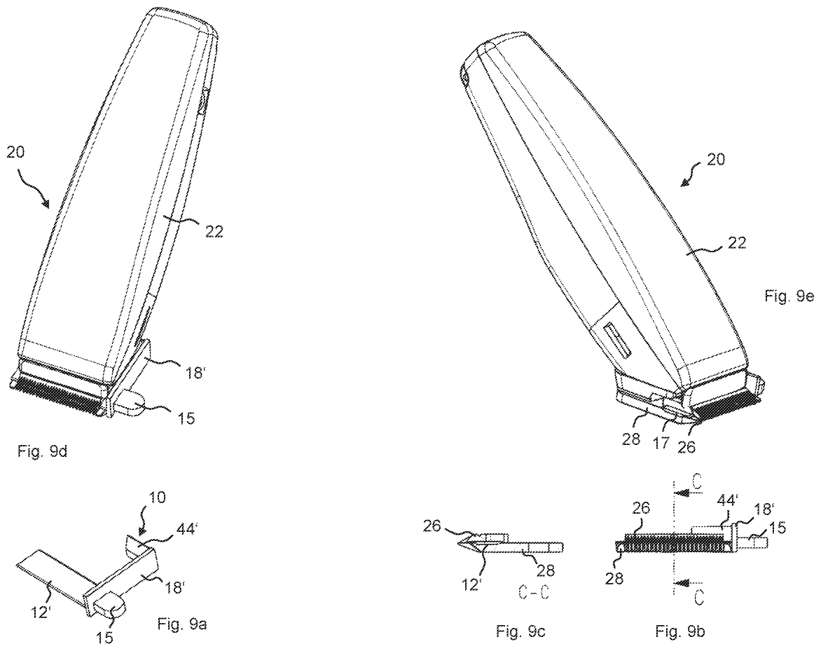

FIG. 9a shows a perspective view of an adjusting device according to the invention according to a sixth embodiment of the present invention.

In contrast to the adjusting devices described above, the adjusting device 10 shown in FIG. 9a has a bottom 12′ which is web-like and dimensioned in such a way that it is inserted into a slot 17 provided between the shaving comb 28 and the shear blade 26 in the installed state, as shown in FIG. 9e. The positioning of the shear blade 26 with respect to the shaving comb 28 takes place via the slot 17.

The web-like bottom 12′ extends essentially perpendicular to a side wall 18′ of the adjusting device 10 and is placed parallel to a rear wall 44′, which is made shorter than the bottom 12′.

The adjusting device 10 has on its side wall 18′ an outwardly extending handle 15 which is used to insert the device into the slot 17, as shown in FIGS. 9a, 9b and 9d.

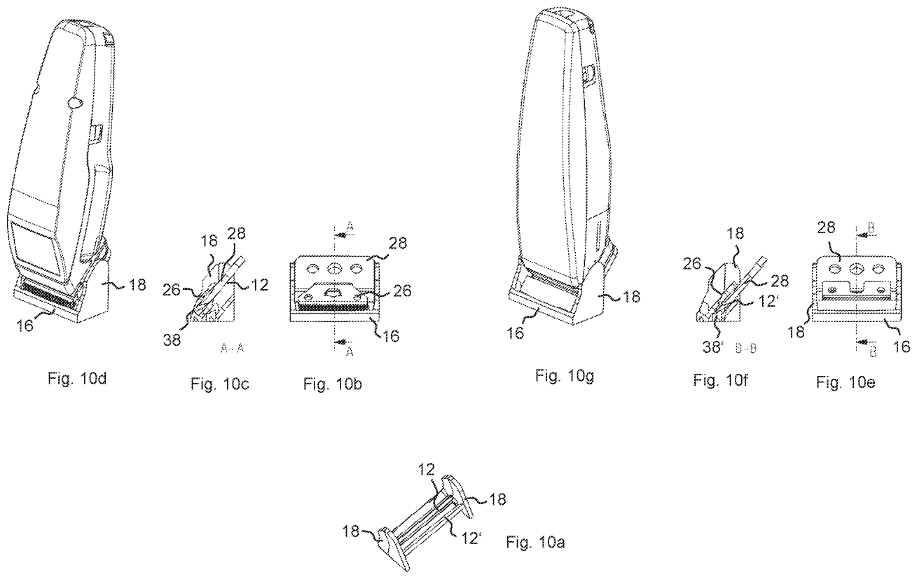

FIG. 10a shows a perspective view of an adjusting device 10 according to the invention according to a seventh embodiment of the present invention. The adjusting device 10 has a front wall 16 which is connected to two laterally arranged side walls 18.

The side walls 18 are firmly connected to two bottoms 12, 12′ of the adjusting device 10, which are arranged parallel to one another, as shown in FIGS. 10a, 10c and 10f. The two bottoms 12, 12′ are inclined with respect to the front wall 16, so that when the hair cutting device 20 is inserted together with the cutting set into the adjusting device 10, the hair cutting device 20 is arranged essentially perpendicular to the adjusting device 10, as shown in FIGS. 10d and 10g.

In FIG. 10c, the shaving comb 28 is inserted together with the shear blade 26 into the first opening of the adjusting device 10, so that the shaving comb 28 is guided along the bottom 12 to the front wall 16 adjoining it, as shown in FIG. 10b, and the adjustment of the distance between the tips of the shaving comb 28 and the shear blade 26 is made after loosening the fasteners.

It should be noted that only the openings provided for the fastening elements in the shaving comb 28 are shown in FIG. 10b. The first opening in the adjusting device 10 is suitable for adjusting the distance between the tips of the shaving comb 28 and the shear blade 26 of a hair cutting device with a radial shear blade guide.

In FIG. 10f, which shows a sectional view along the line BB of FIG. 10e, the cutting set is inserted into the second opening of the adjusting device, the underside of the shaving comb 28 rests against the bottom 12′ and the adjustment of the distance between the tips of the shaving comb 28 and the shear blade 26 of a hair cutting device with a linear shear blade guide is suitable.

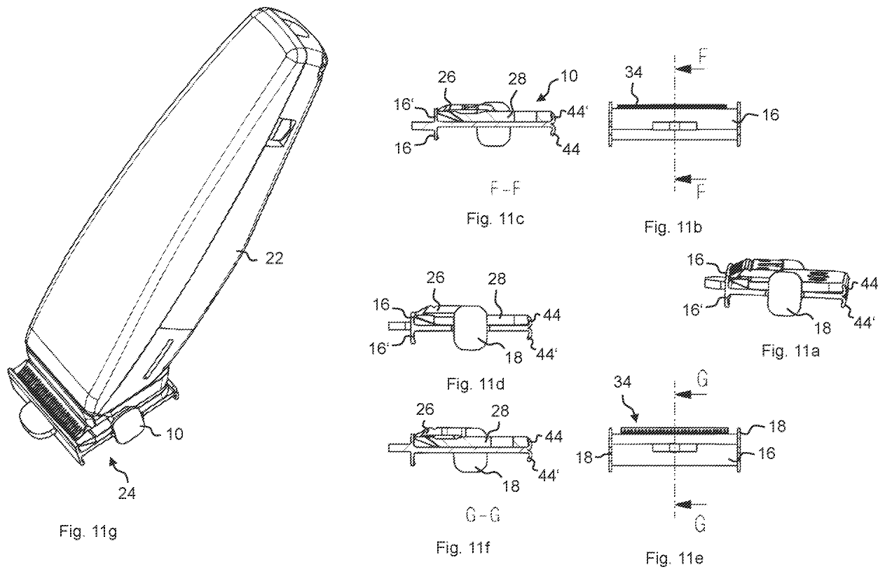

FIGS. 11a-11f show the adjusting device 10 according to a further embodiment of the present invention.

As shown in FIG. 11a, the adjusting device 10 is constructed in such a way that it has a bottom 12 which is connected to a front wall 16, as in the other embodiments, however, the bottom 12 is connected to the front wall 16 substantially in the center thereof. At the rear end of the bottom 12, it spreads into two parts, upwards and downwards, so that the parts each have a rear wall 44. The bottom 12 is connected laterally to two side walls 18, which extend approximately centrally upwards and downwards from the bottom 12 and serve as a lateral boundary for the cutting set and as gripping areas for the adjusting device 10.

The adjusting device 10 shown in FIGS. 11b and 11c is suitable for setting a hair cutting device with a radial shear blade guide. In FIG. 11b, the adjusting device 10 is shown from the front. The edge 34 of the shear blade 26 is in the middle position, as shown in FIG. 11b.

FIG. 11c shows a sectional view along the line F-F of FIG. 11b, from which it can be seen how the shear blade 26 is set in relation to the shaving comb 28. FIGS. 11c and 11d show the double use of the adjusting device 10, namely for a hair cutting device with a radial shear blade guide, as shown in FIG. 11c, and for a hair cutting device with a linear shear blade guide, such as the example shown in FIG. 11d. The two uses of the adjusting device differ in the configuration of the respective projection formed on the front wall 16 or 16′, which is suitable for setting the shear blade 26 with respect to the shaving comb 28.

This embodiment has the advantage that the adjusting device can be used twice, namely once for setting hair cutting devices with a radial shear blade guide, as shown in FIGS. 11b and 11c, and also for setting hair cutting devices with a linear shear blade guide, as shown in FIGS. 11a, 11d, 11e and 11f. It should be noted that the device according to FIGS. 11b and 11c represents the lower of the adjusting devices shown in FIG. 11a.

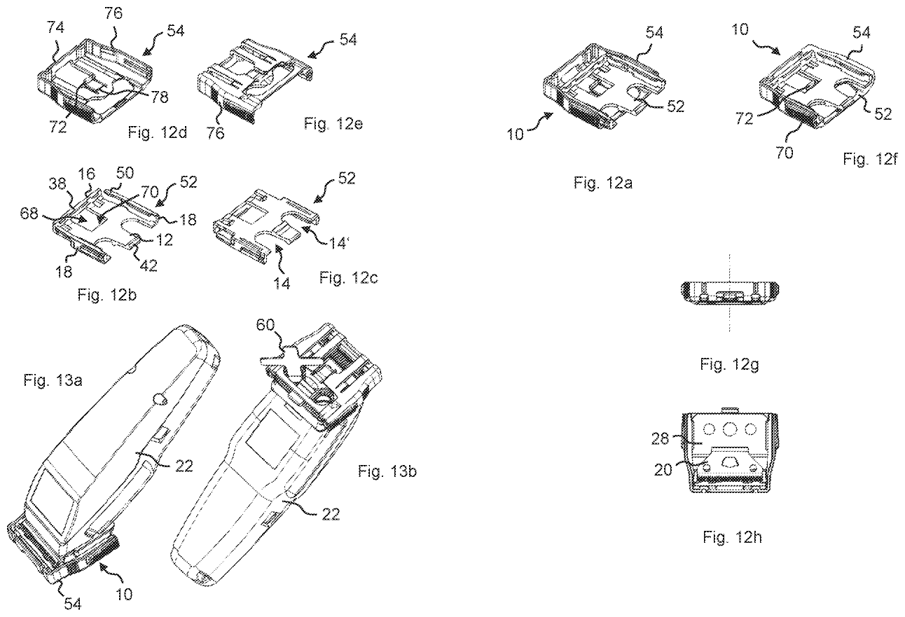

An adjusting device according to a ninth embodiment of the present invention is shown in FIGS. 12a-12h. The adjusting device 10 is constructed in two parts and has a first part 52, as shown in FIGS. 12b and 12c, and a second part 54, as shown in FIGS. 12d and 12e. The first part 52 is dimensioned such that it can be inserted into the second part 54 and held in place by means of a snap connection.

As shown in FIG. 12b, the first part 52 is constructed similarly to the one-piece embodiment according to FIG. 4 and has a bottom 12 which is connected to two side walls 18 which are opposite one another and are arranged parallel to one another.

A front wall 16 is provided on the front part of the bottom 12, which extends upwards, essentially perpendicular to the bottom 12 and has a projection 38 which, in this embodiment, is formed with interruptions on the upper part of the front wall 16.

The projection 38 serves as an abutment surface for the tips of the shear blade 26 corresponding to it in the inserted state, as shown in FIG. 12h. The projection 38 is spaced from the bottom 12 and represents an abutment surface for the tips of the shaving comb 28, as shown in FIG. 12h.

The bottom 12 of the first part 52 of the adjusting device 10 has a recess 68 approximately in the middle, which in this exemplary embodiment forms an abutment 70 opposite the front wall for engaging the second part 54. The second part 54, as shown in FIG. 12d, has a corresponding resting nose 78 in order to enable a snap connection between the two parts 52 and 54, as shown in FIG. 12f.

In FIG. 12a, both parts 52 and 54 are shown in the inserted state. FIG. 12f shows the two parts 52 and 54 of the adjusting device 10 in the engaged state, the resting nose 78 of the second part 54 with the abutment 70 of the first part 52 forming the rest connection.

As shown in FIG. 12d, the second, outer part 54 opposite the resting nose 78 has a protrusion 72 which serves as a lock so that both parts 52 and 54 of the adjusting device 10, which are guided into one another, cannot move relative to one another as long as the cutting set has not yet been inserted into the adjusting device 10.

The first, inner part 52 of the adjusting device 10 forms a receptacle for the cutting set, wherein the shaving comb rests on the inner surface of the inner part 52 and is held pretensioned by it. The second, outer part 54 of the adjusting device 10 is used to hold the pretension.

The first part 52 and the second part 54 are, as shown in FIGS. 12a and 12f, displaceable relative to one another in order to press the shear blade into a central position. The spring tongues 50 of the first part 52, as shown in FIG. 12b, serve to fix the shear blade in a central position after the parts 52 and 54 have been pushed together.

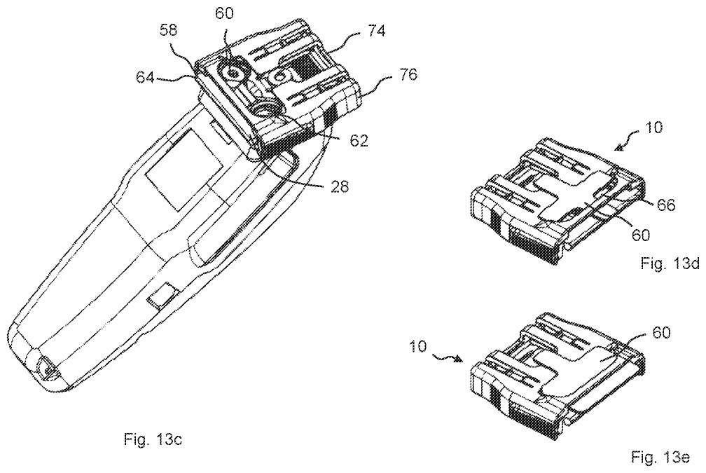

The side walls 18 of the first part 52 each have on their outer sides adjoining the second part 54 a web 58 extending in the longitudinal direction for the axial guidance of the second part 54, as shown in FIG. 13c.

The second part 54 is configured in such a way that it has an elongated recess 64, which is configured in the form of a groove, on the corresponding walls 76, for receiving the respective adjacent web 58, as shown in FIG. 13c.

As shown in FIGS. 13d and 13e, a recess 66 formed in the respective bottom 12 for receiving a tool 60 is provided in the second part 54 of the adjusting device, the tool 60 being in a completely closed or also in an open position, adjusting device can be gripped and removed in order to at least partially release the connecting elements 62 of the shaving comb 28, as shown in FIG. 13c.

Thus, in a simple manner, the connection between the shaving comb and the shear blade is released and an adjustment is made without completely detaching the two parts from the hair cutting device.

### LIST OF REFERENCE SYMBOLS

10 adjusting device
11 support surface
12, 12′ bottom
14 recess
15 handle
16, 16′ front wall
17 slot
18, 18′ side wall
19 projection of the side wall
20 hair cutting device
22 device housing
24 cutting set
26 shear blade
28 shaving comb
30 shear blade tips
32 comb tips
34 edge of the shear blade
36 edge of the shaving comb
38 projection
38′ abutment
40 slope of the projection
42 snap hook
44, 44′ rear wall
46 gripping areas
48 guides of the side walls
50 spring tongue
52 first part of the adjusting device
54 second part of the adjusting device
56 outer side of the side wall 18
58 web
60 tool
62 connecting element
64 recess (groove)
66 recess for the tool 60
68 recess fort the first part
70 abutment for locking function
72 protrusion
74 front wall of the second part 54
76 side wall of the second part 54
78 resting nose for locking function

1. Adjustment device (10) for a hair cutting device (20), wherein the hair cutting device (20) has a device housing (22) and a cutting set (24) which can be connected to the device housing (22), the cutting set (24) consisting of a shear blade (26), which comprises shear blade tips (30), and a shaving comb (28) in connection therewith and comprising comb tips (32), and wherein the shaving comb (28) is connected to the shear blade (26) by means of at least one connecting element (62) and can thus also be releasably connected to the hair cutting device (20), characterized in that the adjusting device (10) is dimensioned in such a way that it can receive and hold the shaving comb (28) so that the shaving comb (28) can be moved to the device housing (22) together with the adjusting device (10) after loosening the at least one connecting element (62), so that a distance between the shear blade tips (30) and the comb tips (32) can be set.

2. Adjustment device (10) according to claim 1, characterized in that the shaving comb (28) rests in a defined manner with the comb tips (32) on the adjusting device (10).

3. Adjustment device (10) according to claim 1, characterized in that the adjusting device (10) is positioned together with the shaving comb (28) such that the adjusting device (10) rests in a defined manner on the shear blade tips (30) of the shear blade (26).

4. Adjustment device (10) according to claim 1, characterized in that the adjusting device (10) has a bottom (12), a front wall (16) extending perpendicular to the bottom (12) and at least one side wall (18) extending perpendicular to the bottom (12) for receiving and holding the shaving comb (28) and the shear blade (26) attached thereto.

5. Adjustment device (10) according to claim 1, characterized in that the bottom (12) includes at least one recess (14), which corresponds to the at least one connecting element (62) of the shaving comb (28), for releasing the at least one connecting element (62) of the shaving comb (28), and wherein the front wall (16) of the adjusting device (10) at a front end of the adjusting device (10) remote from the hair cutting device (20) has an inwardly projecting projection (38) for setting a certain offset distance between an edge (36) of the shaving comb (28) and an edge (34) of the shear blade (26).

6. Adjustment device (10) according to claim 5, characterized in that the projection (38) is formed protruding on an upper edge of the front wall (16) so that it has an abutment (38′) for the shear blade (26), the shaving comb (28) lying under the shear blade (26) being arranged under the abutment (38′) in the assembled state of the cutting set (24).

7. Adjustment device according to claim 6, characterized in that the abutment (38′) extends downward in the direction of the bottom (12) of the adjusting device (10) tapering to form a slope (40) or has a rounding, the abutment (38′) extends elongated on the inside of the front wall (16).

8. Adjustment device (10) according to claim 1, characterized in that opposite to the front wall (16) a rear snap hook (42) for locking the shaving comb (28) and the shear blade (26) is provided.

9. Adjustment device (10) according to claim 1, characterized in that the adjusting device (10) has two mutually parallel side walls (18) which are connected to the front wall (16) and lateral guides (48) for the parallel alignment of the shaving comb (28) and the shear blade (26) on the inside, and gripping areas (46) on the outside.

10. Adjustment device (10) according to claim 1, characterized in that the adjusting device (10) has two side walls (18) extending parallel to one another, which are connected to the front wall (16) and having lateral guides (48) on the inside for the parallel alignment of the shaving comb (28) and the shear blade (26), the guides (48) being configured as spring tongues.

11. Adjustment device (10) according to claim 1, characterized in that the adjusting device (10) comprises a bottom (12), a front wall (16) extending perpendicular to the bottom (12) and a rear wall (44, 44′) extending perpendicular to the bottom (12) for receiving and holding the shaving comb (28) and the shear blade (26) attached thereto, wherein lateral limits for the precise positioning of the shaving comb (28) and the shear blade (26) connected therewith and for holding the adjusting device (10) are provided, and wherein the bottom (12) is placed approximately centrally between the front wall (16) and the rear wall (44, 44′).

12. Adjustment device (10) according to claim 11, characterized in that the front wall (16) has an elongated projection (38) at an upper end and at a lower end for adjusting the shaving comb (28) and the shear blade (26), and that the rear wall (44) is curved inwardly at an upper end and a lower end in order to hold the shaving comb (28) and the shear blade (26) in the position set relative to one another.

13. Adjustment device (10) according to claim 11, characterized in that the bottom (12) is configured in two parts, the two parts in the longitudinal direction of the adjusting device (10) running parallel to one another and firmly connected to one another, and to their two opposite ends extend upwards and downwards so that they form a box.

14. Adjustment device according to claim 11, characterized in that the bottom (12) at its rear end opposite the cutting set (24) includes a rear wall (44) extending upwardly substantially perpendicular to the bottom (12) and a rear wall (44′) extending downwardly substantially perpendicular to the bottom (12).

15. Adjustment device according to claim 1, characterized in that the adjusting device (10) has a bottom (12), a side wall (18), a front wall (16) and a rear wall (44), so that these form a box open to the side, in which the hair cutting device (20) with the built-in cutting set (24) can be inserted from the side, wherein the front wall (16) has a lateral projection (38) which comprises an abutment (38′) for adjusting the shear blade (26) with respect to the shaving comb (28).

16. Adjustment device (10) according to claim 1, characterized in that the adjusting device (10) has a bottom (12′) which is web-like and dimensioned in such a way that it can be inserted into a slot (17) provided between the shaving comb (28) and the shear blade (26) in the installed state, wherein the positioning of the shear blade (26) with respect to the shaving comb (28) takes place via the slot (17).

17. Adjustment device (10) according to claim 1, characterized in that the adjusting device (10) has a first bottom (12) and a second bottom (12′) which extend parallel to one another and which are in laterally connection with one another by means of side walls (18), which are arranged parallel to one another, wherein the adjusting device (10) having a front wall (16) which is connected to the side walls (18) and is arranged essentially perpendicular to the side walls (18), wherein the first and the second bottom (12, 12′) extend from the front wall (16) at an angle of approximately 50° upwards in the direction of a hair cutting device (20) to be inserted.

18. Adjustment device (10) according to claim 17, characterized in that the front wall (16) includes a projection (38, 38′) on each of its surfaces corresponding to the two bottoms (12, 12′) for adjusting the shear blade (26) relative to the shaving comb (28).

19. Adjustment device (10) according to claim 1, characterized in that the adjusting device (10) is formed in one piece.

20. Adjustment device according to claim 1, characterized in that the adjusting device (10) is configured in at least two parts, a first, inner part (52) which forms a receptacle for the cutting set (24) and holds it pretensioned, and a second, outer part (54) for holding the preload, the first part (52) and the second part (54) being displaceable relative to one another in order to push the shear blade (26) into a central position.

21. Adjustment device according to claim 20, characterized in that the first part (52) includes a bottom (12), a front wall (16) and two side walls (18) which are connected to the bottom (12) and at their parts adjoining the front wall (16) each comprises a spring tongue (50) for fixing the shear blade (26) in a central position.

22. Adjustment device according to claim 20, characterized in that the first part (52) and the second part (54) of the respective front wall (16) each comprise corresponding recesses (14) opposite each other, which correspond with the at least one of the connecting elements (62) of the shaving comb (28).

23. Adjustment device according to claim 20, characterized in that the side walls (18) of the first part (52) on their outer sides adjoining the second part (54) each have a longitudinally extending web (58) for the axial guidance for the second part (54), wherein the second part (54) is configured in such a way that it has corresponding side walls (18), each of which have an elongated recess (64) or groove for receiving the respective adjacent web (58).

24. Adjustment device according to claim 20, characterized in that the second part (54) has a bottom (12), on whose inner surface opposite the shaving comb (28) is provided a projection for locking the shaving comb (28).

25. Adjustment device according to claim 20, characterized in that in the first (52) and/or in the second part (54) of the adjusting device (10) a recess (66) formed in the respective bottom (12) for receiving of a tool (60) is or are provided, the tool (60) being graspable and removable in a fully closed position of the adjusting device in order to at least partially release the connecting elements (62) of the shaving comb (28).

26. Adjustment device according to claim 25, characterized in that the recess (66) provided in the first (52) and/or second (54) part for receiving the tool (60) is configured as a continuous opening which is circular, cross-shaped or is polygonal in shape and suitable for securely receiving the tool (60).
